(19) United States
(12) Patent Application Publication
(10) Pub. No.: US 2026/0071666 A1
(43) Pub. Date: Mar. 12, 2026

(54) CATCH-PROOF CHAIN LINK

(71) Applicant: Michael W. Humcke, Pewaukee, WI (US)

(72) Inventor: Michael W. Humcke, Pewaukee, WI (US)

(21) Appl. No.: 18/828,143

(22) Filed: Sep. 9, 2024

(51) Int. Cl. F16G 13/07; F16G 15/12

(52) U.S. Cl. CPC F16G 13/07; F16G 15/12

(57) ABSTRACT

An investment cast, stainless steel chain link for use a part of a chain. The chain link includes a pair of spaced first and second sidebars that each extend between forward and rear ends of the chain link. A reinforcing rib is formed on each sidebar and is flush with the forward and rear ends of the chain link. A barrel is formed at the rear end of the sidebars. The forward end of the sidebars includes either a first or a second attachment boss. The first attachment boss includes a pin head receptacle that allows the head of the chain pin to be flush with an outer surface of the first attachment boss. A retaining pin extends through the second attachment boss to prevent axial movement of the chain pin. In one embodiment, the chain pin is rotatable and, in another embodiment, the chain pin is prevented from rotating.

### BACKGROUND

The present disclosure generally relates to chain constructions employed in municipal and industrial water and wastewater conveyor type treatment systems, grain conveyance equipment, and material handling conveyors. More specifically, the present disclosure relates to a stainless-steel chain link produced in an investment casting process that eliminates all areas that can catch material or contact and catch on adjacent equipment and collector basins during operation, thus eliminating equipment failures and unscheduled outages.

Sludge, waste solids and scum collector mechanisms are commonly used in water and wastewater treatment tanks to remove debris and settled sludge from the bottom of collection tanks, to skim the floating grease and solids from the surface of collection tanks, and for removing grit and trash from wastewater and process streams. These chain mechanisms are also used for grain and material handling conveyors. Typically, such collector and conveyor mechanisms include a single continuous strand of chain, or a pair of continuous chain strands spaced apart continuously articulating chains trained over collector chain sprockets which are mounted on cross shafts supported on the sidewalls of the tank or equipment, and elongated transverse collector flights, scrapers, skimmers, or conveyor buckets attached to the strands of chains. Collector and conveyor mechanisms may be oriented horizontally, vertically or in a combination of horizontal and/or vertical designs. One set of the sprockets is driven so that the chain loops revolve to provide a succession of collector and conveyor flights along a bottom of the mechanism as well as along the surface of the water in the mechanism basin to accomplish the collection, conveying, and skimming functions. Other mechanisms operate to screen debris, and collect grit from the wastewater stream, or to collect, convey and transport grain or move material solids. Successive collector flights, cleaning rakes, and bucket type components gather, push, collect and discharge scum, sludge, screenings and abrasive solids and debris into collection areas of the tank or mechanism for removal, collection or conveyance.

U.S. Pat. Nos. 7,237,375 and 7,343,730 provide an investment cast, stainless steel chain link for use in water and wastewater treatment. The chain link includes a pair of spaced apart, offset (non-parallel) elongated sidebars having forward ends and rearward ends. The horizontal edges of the chain sidebars can be parallel or can have a curved chain-saver feature to distribute load and wear between the sprocket teeth and support rims. The forward ends are spaced apart and are provided with outwardly and laterally extending bosses having transverse boss pin bores coaxially aligned with each other. The rearward ends are interconnected by a cylindrical barrel having a barrel pin bore extending through each of the sidebars. The sidebars are formed with outwardly and laterally projecting reinforcing ribs extending between the bosses and the barrel pin bore along a substantial length of the sidebars. The interconnected rearward ends of a first pair of sidebars are disposed between the separated forward ends of a second pair of sidebars such that the barrel pin bore is coaxially aligned with the boss pin bores. A chain pin is insertable through the aligned boss and barrel pin bores for interconnecting the first and second pairs of sidebars, the chain pin being freely rotatable relative to the sidebars. An arrangement is provided for preventing the lateral dislodgement of the chain pin from the sidebars.

In the prior art chain links referred to above, the sidebars have upper and lower linear edges which are generally parallel to each other. The rearward ends of the sidebars are generally parallel to each other, and the forward ends of the sidebars diverge away, or are offset from each other. The forward ends of the sidebars are provided with outwardly and laterally extending circular bosses. The bosses have external surfaces which are flat, smooth and uninterrupted. The reinforcing ribs have longitudinal axes which run generally parallel to the upper and lower edges of the sidebars. The sidebars of the reinforcing ribs form T-shaped cross sections. The surfaces of the sidebars coextensive with the barrel are offset inwardly from the external surfaces of the bosses. The chain pin has an elongated cylindrical shaft portion having at one end, a smooth cylindrical flat head and, at an opposite end, a throughhole. The arrangement for preventing lateral dislodgment of the chain pin is a cotter pin in the throughhole. The head of the chain pin rotates freely relative to one of the boss external surfaces. A flight supporting attachment bracket may project integrally from the chain link.

Although such chain links have proven effective and durable, a need and a desire exist for an improved chain link design that reduces the amount of debris that collects on the links during usage, and also prevents the chain sidebars from contacting or catching on equipment surfaces. The inventor has recognized this desire, and the present disclosure improves upon current chain link designs and provides upgraded and improved chain geometry compatible for lost wax investment casting without creating stress risers or casting induced material occlusions, flaws and weaknesses.

### SUMMARY

The present disclosure relates to a chain link for use in municipal and industrial water and wastewater treatment, and for grain and material handling conveyors. In one exemplary embodiment, the chain link of the present disclosure includes a first and second sidebar, each having a forward and rear end, with the forward ends being spaced further apart than the rearward ends. A barrel extends between the spaced rear ends of the first and second sidebars, including a barrel pin bore and a flat boss contact surface on each of the first and second sidebars. A first attachment boss is formed on the forward end of the first sidebar and a second attachment boss is formed on the forward end of the second sidebar. Each of the first and second attachment bosses includes a flat inner barrel contact surface, a flat outer surface, and a boss pin bore extending through the attachment boss. Differing from the prior art, the chain link also includes a continuous recessed reinforcing rib between the chain link barrel and the chain link pin boss, extending outwardly from the beam portion, with a forward end and a rear end, wherein the forward end is flush with or recessed from the flat outer surface of the first or second attachment boss and the rear end is flush with the flat boss contact surface of the barrel. A chain pin is insertable through the boss pin bores of the second chain link and the barrel pin bore of the first chain link for interconnecting the first chain link with the second chain link. In one embodiment, the chain pin is rotatable, and in another embodiment, the chain pin is prevented from rotating.

In another embodiment of the present disclosure, the chain link includes a first and second sidebar, each having a forward and rear end, with the forward ends being spaced further apart than the rearward ends. A barrel extends between the spaced rear ends of the first and second sidebars, including a barrel pin bore and a flat boss contact surface on each of the first and second sidebars. A first attachment boss is formed on the forward end of the first sidebar and a second attachment boss is formed on the forward end of the second sidebar. Each of the first and second attachment bosses includes a flat inner barrel contact surface, a flat outer surface, and a boss pin bore extending through the attachment boss. The barrel extending between the spaced rear ends of the first and second sidebars of the first chain link are disposed between the spaced forward ends of a second chain link such that the barrel pin bore of the first chain link is coaxial with the boss pin bores formed in the first and second attachment bosses of the second chain link. A chain pin is insertable through the boss pin bores of the second chain link and the barrel pin bore of the first chain link for interconnecting the first chain link with the second chain link. A retaining pin is inserted into the second attachment boss and engages a contact end of the chain pin to prevent axial removal of the chain pin. The retaining pin is flush with both upper and lower edges of the second attachment boss while the pin head of the chain pin is flush with or recessed from the flat outer surface of the first attachment boss.

In yet another embodiment, chain link comprises a first and second sidebar, each having a forward and rear end, with the forward ends being spaced further apart than the rearward ends. A barrel extends between the spaced rear ends of the first and second sidebars, including a barrel pin bore and a flat boss contact surface on each of the first and second sidebars. A first attachment boss is formed on the forward end of the first sidebar and a second attachment boss is formed on the forward end of the second sidebar. Each of the first and second attachment bosses includes a flat inner barrel contact surface, a flat outer surface, and a boss pin bore extending through the attachment boss. The chain link also includes a continuous reinforcing rib extending outwardly from the beam portion, connecting the forward end and the rear end of the chain link, wherein the forward end is flush with or recessed from the flat outer surface of the first or second attachment boss and the rear end is flush with the flat boss contact surface of the barrel.

Various other features, objects and advantages of the invention will be made apparent from the following description taken together with the drawings.

### BRIEF DESCRIPTION OF THE DRAWINGS

The drawings illustrate the best mode presently contemplated of carrying out the disclosure. In the drawings:

FIG. 1 is a sectional view of a wastewater treatment tank including collector chains including the chain links of the present disclosure;

FIG. 2 is a perspective view of two chain links of a first embodiment joined to each other by a chain pin of a first embodiment;

FIG. 3 is a top view of one of the chain links of the first embodiment;

FIG. 4 is a section view taken along line 4-4 of FIG. 3;

FIG. 5 is a side view of one of the chain links of the first embodiment;

FIG. 6 is a top view of the chain pin used between chain links in accordance with the first embodiment;

FIG. 7 is perspective view of a chain link of a second embodiment and a chain pin of the second embodiment; and

FIG. 8 is a partial section view of a portion of the chain link and chain pin of the second embodiment.

### DETAILED DESCRIPTION

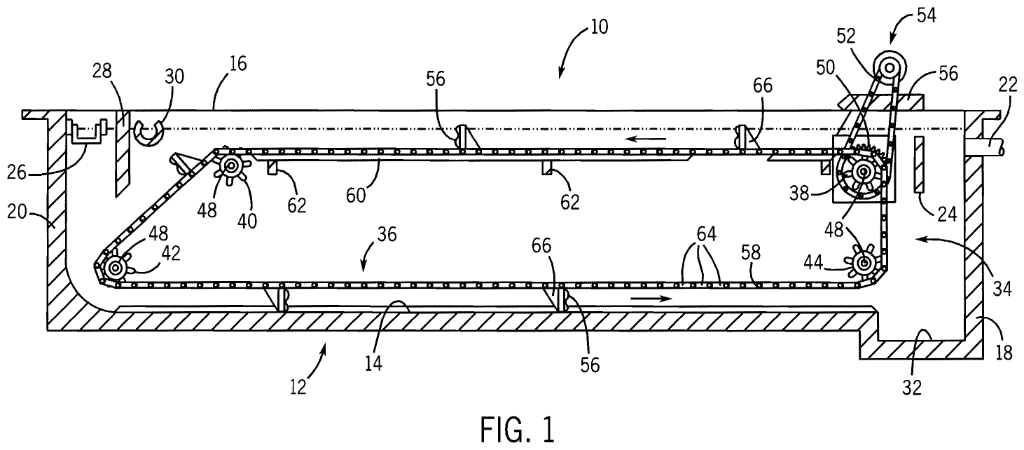

Illustrated in FIG. 1 is one type of material conveyor for sediment removal or wastewater treatment apparatus 10 which embodies the chain construction of the invention, and which functions to transport and remove waste material such as settleable solids or sludge, grit, trash, debris and floatable waste or scums from wastewater, although other solid materials can be conveyed or treated.

The wastewater treatment apparatus 10 includes a primary sedimentation or settling tank 12 which is usually formed with reinforced concrete or steel. The tank 12 includes a bottom 14, a pair of opposite sidewalls 16 (one is shown), an influent endwall 18, and an effluent end wall 20, which together defines the tank 12. A conduit 22 extends through the influent endwall 18 for delivering wastewater into the tank 12. A first baffle 24 extends across the top of the tank 12, between the sidewalls 16 and downwardly in front of and somewhat below the conduit 22 to minimize the movement and turbulence created by the influent flow to less than 1 foot per minute. The wastewater flows steadily through the tank 12 from the influent endwall 18 to the effluent endwall 20 where one or more box weirs 26 (one is shown) are located to provide transverse channels for the flow of wastewater out of the tank 12. A second baffle 28 extends across the tank 12 in a position upstream of the effluent endwall 20 to permit floating waste from floating downstream to the weir 26. The tank 12 is also provided with scum and sludge collection troughs 30 and 32, respectively, positioned upstream of the second baffle 28 and adjacent the influent endwall 18 for the eventual removal of wastes from the tank 12.

As the wastewater flows through the tank 12, the sludge and abrasive materials settle to the bottom 14 while the scum floats to the surface of the wastewater. Accordingly, the wastewater treatment apparatus 10 also includes a waste collector mechanism or apparatus 34 supported in the tank 12 for removing the floating and submerged waste.

The collector apparatus 34 includes a single or a pair of endless chains 36 (only one is shown), each located adjacent one of the sidewalls 16 and the construction of which will be more fully explained below. The endless chains 36 are arranged in single continuous strands or two strands that are parallel to each other and are trained around toothed sprockets 38, 40, 42 and 44 which each engage the chains 36 to guide their travel in the tank 12. Each pair of sprockets 38, 40, 42, and 44 is mounted on one of four transversely extending shafts 48, the ends of which are rotatably mounted in bearings (not shown) secured in the sidewalls 16. To rotate the chains 36 within the tank 12, the shaft 48 for the pair of sprockets 38 has a driving sprocket 50 secured thereto and engaged by a driving chain 52 extending downwardly from a power drive unit 54 mounted on a platform 55 above the tank 12. The chains 36 are driven in a counterclockwise direction.

The endless chains 36 serve as carriers for a plurality of elongated collector flights 56 which extend transversely between the chains 36 and at sequential positions along the chains 36. An example of a suitable collector flight is illustrated in U.S. Pat. No. 4,663,042 issued May 5, 1987, to Rasper et al. and the disclosure of this patent is incorporated herein by reference. As the endless chains 36 travel within the tank 12, the flights 56 are guided in a lower run along the bottom 14 to scrape sludge therefrom, and in an upper run along the surface of the wastewater to skim floating waste from the surface.

To guide the flights 56 in the lower run, lower tracks or rails 58 (only one is shown) are embedded in the bottom 14. To support the chains 36 while in the upper run, longitudinally extending upper tracks or rails 60 (only one is shown) are secured along the sidewalls 16 using a pair of spaced apart brackets 62. The upper rails 60 are located at such an elevation that the flights 56 are partially submerged in the wastewater as they ride along the rails 60. During operation of the collector apparatus 34, the revolving chains 36 provide a succession of collector flights 56 in the upper run to skim floating waste from the surface of the wastewater. The floating waste is thereafter received in the scum trough 30 for discharge from the tank 12. The revolving chains 36 also provide a succession of flights 56 in the lower run to scrape the settled sludge from the bottom 14 for deposit into the sludge trough 32. The sludge is pumped from the sludge hopper or trough 32 intermittently or continuously in accordance with the process requirements.

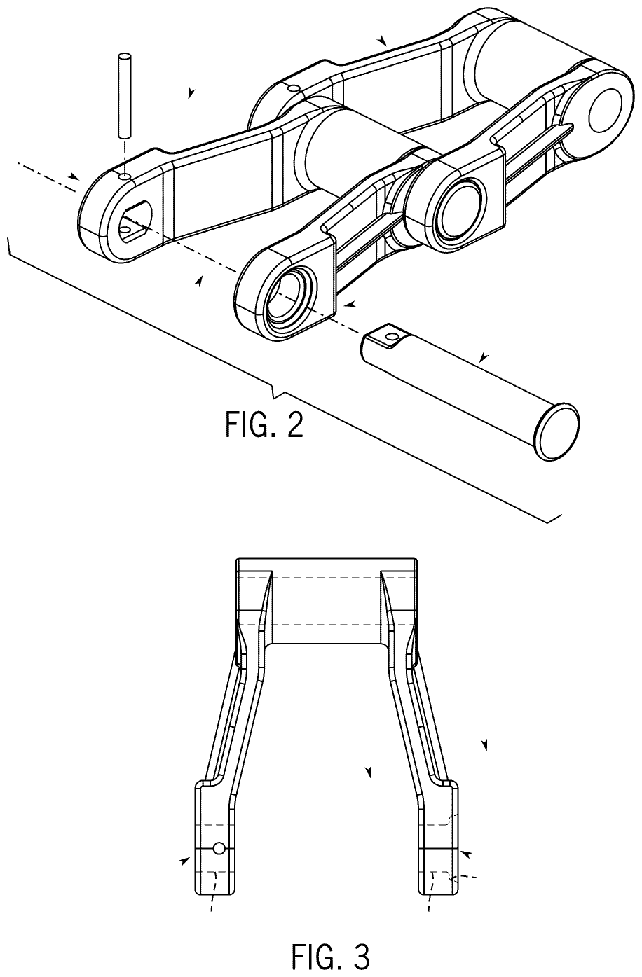

The endless chains 36 of the present disclosure are preferably identical and are configured of a plurality of adjacently connected chain links, as depicted in FIGS. 2-8, according to the present disclosure. In an exemplary embodiment, each chain link is constructed of precipitation hardening, martensitic, or austenitic stainless steel alloys, or other carbon steel alloys, from an investment casting process, although other materials and forming processes are contemplated as being within the scope of the present disclosure.

FIG. 2 illustrates a pair of chain links 64 constructed in accordance with a first embodiment of the present disclosure. In the configuration shown in FIG. 2, the pair of chain links 64 are interconnected with each other by a chain pin 66 such that a series of chain links 64 can be interconnected with each other to form the continuous length of chain 36 shown in FIG. 1. Although only a pair of chain links 64 is shown in the embodiment of FIG. 2, it should be understood that a significantly larger number of chain links 64 can be joined to each other to form the continuous length of chain 36. As can be understood in FIG. 2, each of the chain links 64 has an identical shape and is formed from a one-piece unitized casting, preferably an investment casting. The identical chain links 64 can be used to form each link of a continuous section of chain.

As shown in FIGS. 2 and 3, each chain link 64 includes a first sidebar 68 and a second sidebar 70 that are spaced from each other. In the embodiment illustrated, each of the sidebars 68, 70 has a curved shape to define non-parallel sidebars that are commonly referred to as offset sidebars. Although offset sidebars are shown, it is contemplated that straight, parallel sidebars could be used with the chain link 64 of the present disclosure.

Each of the first and second sidebars 68, 70 extends from a rear end 72 to a forward end 74 and includes a curve in the sidebar between the rear end 72 and the forward end 74. The rear end 72 and forward end 74 are labeled relative to the direction of typical movement of the chain. As shown in FIGS. 2 and 3, the rear ends 72 of the pair of first and second sidebars 68, 70 are joined by a barrel 76. The barrel 76 is integrally cast with the pair of first and second sidebars 68, 70 to provide a unitary structure. The barrel 76 includes a barrel pin bore 78 that extends through the entire length of the barrel 76 and is open at each end through the pair of sidebars 68, 70. The barrel pin bore 78 has an internal diameter and opens at each end to one of the flat boss contact surfaces 80. The boss contact surface 80 is generally planar and is formed at the rear end 72 of both the first and second sidebars 68, 70. The barrel pin bore 78 opens into the boss contact surface 80 and provides an access point for receipt of the chain pin 66 when the chain links 64 are joined together as shown.

As is shown in FIGS. 2 and 3, the first sidebar 68 includes a first attachment boss 82 while the second sidebar 70 includes a second attachment boss 84. The first and second attachment bosses 82, 84 have generally the same size and profile but include different features to facilitate the insertion and retainment of the chain pin 66 as will be described in greater detail below. Both the first and second attachment bosses 82, 84 include a generally flat inner barrel contact surface 86 and a generally flat outer surface 88. The first and second attachment bosses 82, 84 each include a curved end surface 90 that provides a smooth transition from an upper edge 92 to a lower edge 94 of the respective attachment boss.

The first attachment boss 82 includes a pin head receptacle 96 that is recessed from the flat outer surface 88 of the first attachment boss 82. The pin head receptacle 96 has an initial outer diameter edge portion 98 and tapers inwardly to define a recessed inner edge 100 as best shown in FIG. 5. The recessed inner edge 100 has a diameter that is less than the diameter of the outer edge portion 98 such that the portion of the pin head receptacle 96 that transitions to the outer surface 88 has an expanded diameter as compared to the remainder of a boss pin bore 102 that extends through the entire width of the first attachment boss 82.

As illustrated in FIG. 3, the second attachment boss 84 includes a similar boss pin bore 102 that extends through the entire width of the second attachment boss 84 from the inner barrel contact surface 86 to the outer surface 88. The boss pin bore 102 formed in the first attachment boss 82 is sized to allow the shaft 104 of the chain pin 66 to freely pass through the first attachment boss 82.

Referring back to FIG. 5, the recessed inner edge 100 of the pin head receptacle 96 has a diameter that is less than the diameter of a pin head 106 formed on the chain pin 66. The difference in size prevents the chain pin 66 form passing through the first attachment boss 82 and thus limits the axial movement of the chain pin 66 in a first direction. When the chain pin 66 is used to join two chain links 64, the pin head 106 is flush with the outer surface 88 of the first attachment boss 82, as illustrated in FIG. 2. It is also contemplated that the pin head 106 could be slightly recessed from the outer surface 88. However, in order to prevent any material from being caught or collected by the pin head 106 during use of the chain assembled from the chain links 64, the pin head 106 should be flush or slightly recessed from the outer surface 88.

As shown in FIG. 2, the second attachment boss 84 includes an pin opening 108 that is formed in the inner barrel contact surface 86. The pin opening 108 provides access to the boss pin bore 102 formed within the second attachment boss 84. The pin opening 108 includes a flat top edge 110 and a flat bottom edge 112 that are joined by a pair of curved side walls 114. The flat top and bottom edges 110 and 112 are designed to engage a pair of flat faces 116 on the contact end 118 of the shaft portion 104 of the chain pin 66. The contact faces 116 are spaced from each other by the same distance as the spacing between the top edge 110 and bottom edge 112 of the pin opening 108. In this manner, when the contact end 118 of the chain pin 66 is received within the pin opening 108, the interaction between the pin opening 108 and the contact end 118 prevents rotation of the chain pin 66.

In the embodiment shown, the second attachment boss 84 includes a retaining pin opening 120 that is sized to receive a retaining pin 122. When a pair of chain links 64 are assembled as shown, the retaining pin 122 extends into the retaining pin opening 120 and passes through a corresponding retaining pin opening 124 formed in the contact end 118 of the chain pin 66. When the retaining pin 122 is received as described, the retaining pin 122 prevents movement of the chain pin 66 along its longitudinal axis, thereby preventing the chain pin 66 from becoming separated from the position in which the chain pin 66 interconnects the pair of chain links 64. As shown in FIG. 2, each end 126 of the retaining pin 122 is flush with either the upper edge 92 or the lower edge 94 of the second attachment boss 84 when in use. The flush mounting of the ends 126 of the retaining pin 122 prevents the retaining pin 122 from catching any debris or material during use of the chain comprised of the series of interconnected chain links 64.

As can be understood in FIGS. 2 and 3, the inner barrel contact surfaces 86 formed on each of the pair of first and second attachment bosses 82, 84 are spaced from each other by a distance sufficient to receive the rear end 72 of the chain link. As shown in FIG. 2, the boss contact surface 80 formed on each of the rear ends 72 of the first and second sidebars 68, 70 come into contact with the inner barrel contact surface 86 formed on the spaced first and second attachment bosses 82, 84. In this position, the boss pin bore 102 formed in the first attachment boss 82 is aligned with the barrel pin bore 78. In addition, the barrel pin bore 78 is aligned with the boss pin bore 102 formed in the second attachment boss 84. As described, the boss pin bore 102 formed in the second attachment boss 84 is restricted by the top edge 110 and bottom edge 112. When the rear end of one chain link 64 is received between the attachment bosses 82, 84 of another chain link, the aligned bores allow the chain pin 66 to be inserted to join the pair of chain links as shown in FIG. 2.

As described previously, when the chain pin 66 is received between the pair of chain links 64, the pin head 106 is flush with the outer surface 88 of the first chain link. Once the chain pin 66 is installed, the retaining pin 122 is inserted into the second attachment boss 84 such that it passes through the retaining pin opening 124 formed in the contact end 118 of the inserted chain pin 66. When installed as shown, the chain pin 66 is prevented from rotating and is also prevented from moving in an axial direction. In this assembled configuration, barrel 76 is able to rotate about the stationary chain pin 66 during operation of the chain.

Since the forward end 74 of each of the first and second sidebars 68, 70 are spaced apart further than the rear end 72, each of the first and second sidebars 68, 70 converges inwardly from the forward end 74 to the rear end 72. Each of the first and second sidebars 68, 70 includes a beam portion 128 that has a smooth inner surface 130. The outer surface 132 of each of the sidebars 68, 70 is recessed from the outer surface 88 of the first and second attachment bosses 82, 84 by a transition shoulder 134. In the embodiment shown in FIGS. 2 and 3, the transition shoulder 134 extends at nearly a perpendicular direction relative to the outer surface 132. However, it should be understood that the shoulder 134 could have an angled configuration, such as at approximately 45°, between the outer surface 88 and the outer surface 132 of the beam portion 128 to create a smoother transition between the attachment bosses and the beam portion 128. The beam portion 128 extends to the rear end 72 and is slightly offset from the boss contact surface 80 by another transition portion 136.

Referring now to FIGS. 2 and 5, each of the first and second sidebars 68, 70 includes a reinforcing rib 138. The reinforcing rib 138 includes a forward end 140 and a rear end 142. The reinforcing rib 138 extends outward relative to the outer surface 132 to provide additional strength and stability for the beam portion 128 that forms the first and second sidebars 68, 70. As shown in FIG. 5, the reinforcing rib includes a pair of side walls 144 that are joined to each other at a peak 146. The configuration of the side walls 144 and the peak 146 further aids in preventing material from being caught on the reinforcing rib 138 during operation.

As best shown in FIGS. 2 and 3, the forward end 140 of each of the reinforcing ribs 138 is either slightly recessed or flush with the outer surface 88 formed on the first and second attachment bosses 82, 84. Likewise, the rear end 142 of each of the reinforcing ribs 138 joins to and is essentially flush with the boss contact surface 80. Again, the flush mounting of the rear end 142 with the boss contact surface 80 prevents material from being caught on the reinforcing rib 138 during operation.

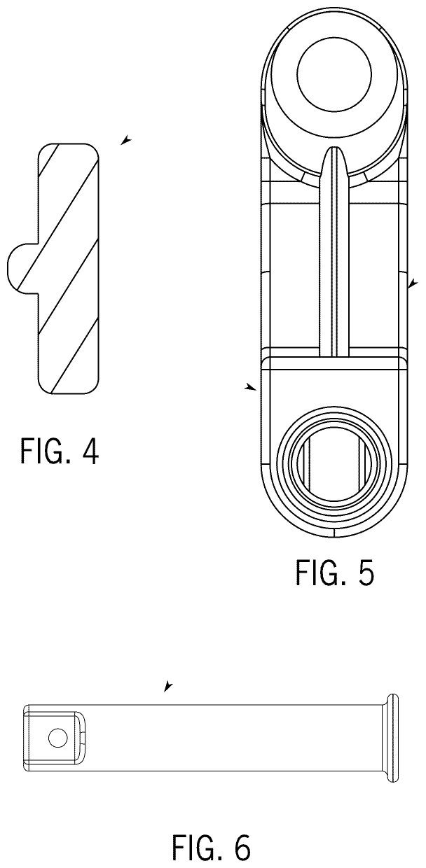

Referring now to FIG. 4, a section view of the first sidebar 68 is shown. As illustrated, the beam portion 128 includes the outer surface 132 and the reinforcing rib 138 that protrudes out past the outer surface 132. The beam portion 128 is strengthened and stabilized by the inclusion of the reinforcing rib 138 which allows for a reduction in the amount of material used to form each of the pair of first and second sidebars 68, 70.

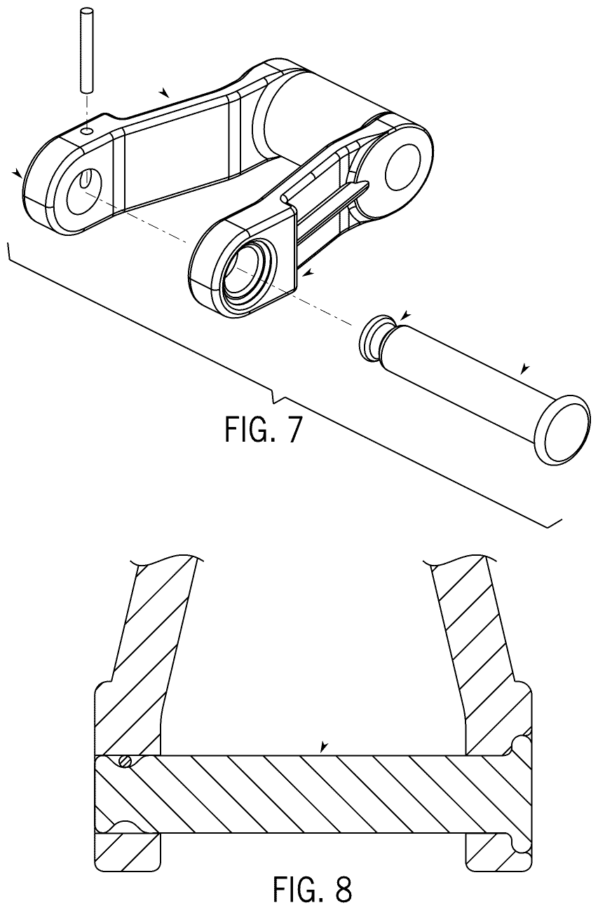

FIG. 7 illustrates a second embodiment of chain link 148. The second embodiment of the chain link 148 has a very similar configuration to the first embodiment shown in FIG. 2. However, the second embodiment of the chain link 148 is designed to allow the chain pin 150 to rotate within the pair of spaced first and second attachment bosses 82 and 84. As shown in FIG. 7, the shaft 104 of the chain pin 150 includes an engagement end 152 that includes a retaining pin groove 154 instead of the flat contact surfaces included on the chain pin 66. The retaining pin groove 154 is recessed from the outer surface 156 and is spaced axially inward from an end portion 158. As shown in FIG. 8, when the chain links 148 are connected to each other, the retaining pin 122 is received within the pin groove 154. The shape of the pin groove 154 allows the entire chain pin 150 to rotate while the end portion 158 and the outer surface 156 prevent axial movement of the chain pin 150. As illustrated in FIG. 8, the pin head 106 is generally flush or slightly recessed from the outer surface 88, as was the case with the first embodiment.

In the embodiment shown in FIG. 7, the retaining pin opening 159 is positioned further from the end surface 90 as compared to the first embodiment of FIG. 2. The additional spacing offsets the retaining pin 122 from the center of the boss pin bore 102. This is required since the retaining pin is offset from the axial center line of the chain pin 150. The location of the retaining pin 122 relative to the chain pin 150 allows the chain pin 150 to rotate relative to the stationary retaining pin 122.

In addition, unlike the first embodiment, the pin opening 160 formed on the inner barrel contact surface 86 is circular and sized slightly larger than the outer diameter of the chain pin 150. This circular shape allows the chain pin 150 to freely rotate within the boss pin bore 102.

As previously noted above, the chain link of the present disclosure is formed from a method of investment casting. The chain links are uniquely cast using an innovative modification of a conventional investment or lost wax casting procedure. Such unique casting method is shown and described in U.S. Pat. No. 7,343,730, the disclosure of which is incorporated herein by reference. Investment casting chain links using stainless steel alloys requires that the chain mold geometry allow for rapid, linear flow of molten metal alloys into the mold cavities, while providing a controlled uniform cooling of the metal mass in the mold to eliminate occlusions, flaws and stress risers. The new reconfigured link and mold geometry and design of the present disclosure eliminates such material defects with a reduced material mass and reduced weight of the chain link while increasing or maintaining the strength of the chain versus the original design geometry

In the past, engineers and manufacturers had to use different chain types and styles to accommodate a required increase in corrosion resistance, abrasion resistance, working load and ultimate strength beyond that offered by conventional cast or fabricated steel chain. Bigger and heavier cast steel chain link and sprocket designs, often with larger diameter and longer chain barrels, thicker and wider chain sidebars, larger diameter and longer chain pins had to be used to obtain these features. With the perfection of the investment casting process chain design and mold geometry that prevents stress risers, occlusions and material flaws in cast stainless steel chains, and, with the usage of precipitation hardening, austenitic and martensitic stainless steels, it now becomes possible to greatly increase corrosion and abrasion resistance, ultimate strength and working load of the chain by using stainless steel chain alloys, rather than increasing the dimensional size and thickness of the chain link.

Due to the use of stainless-steel alloys, sidebar and flow channels and heat dispersing elements used in the investment casting process to form the chain link, problems of corrosive attack, stress risers, heat concentrations, shrinkage and warping are virtually eliminated. In addition, the investment casting process eliminates the need for additional machining and produces a chain link having consistently close dimensional tolerances between the chain pin and pin boss to preclude the entry of grit, sand and other abrasive particles in the chain joint reducing the rate of wear and extending chain link life. Because of the close dimensional tolerances and smooth uniform component surfaces, there is no break-in or wear-in for the chain and no additional maintenance required in tensioning the chain. The investment casting process enables the casting of multiple chain links as well as attachment links offering dramatic savings in time and labor over the traditional one-at-a-time sand casting process. With the perfected investment casting process, it now becomes possible to customize chain links by manipulating their alloy content rather than by increasing the physical size of the chain link.

The chain link produced as a result of the unique investment casting process is designed to include unique geometry since the casting process allows molten metal to get into the mold uniformly and to cool slowly and uniformly. Such properties eliminate the formation of stress risers and stress fractures, occlusion and material defects that result in the loss of physical strength for the chain link. The substantial change in the new chain link geometry, and revision to the mold tooling for the investment casting process, results in a new chain link design with reduced mass and weight over the prior art, while maintaining or exceeding the strength of the original chain design. Chain links constructed according to this molding method can operate for a remarkable full 20-year service cycle (the current American water and wastewater industry process equipment design standard), or longer, without any replacement of either the chain or the sprockets.

This written description uses examples to disclose the invention, including the best mode, and also to enable any person skilled in the art to make and use the invention. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

We claim:

1. A chain link for chains such as used in municipal and industrial water and wastewater treatment, grain conveyors and material handling, the chain link comprising:
a first sidebar and a second sidebar each having a forward end and a rear end, wherein the forward ends of the first and second sidebars are spaced further from each other than the spacing between the rearward ends;
a barrel extending between the spaced rear ends of the first and second sidebars, the barrel including a barrel pin bore and a flat boss contact surface on each of the first and second sidebars;
a first attachment boss formed on the forward end of the first sidebar and a second attachment boss formed on the forward end of the second sidebar, each of the first and second attachment bosses including a flat inner barrel contact surface, a flat outer surface and a boss pin bore extending through the attachment boss, wherein each of the first and second sidebars includes a beam portion extending from the attachment boss to the rear end;
a reinforcing rib extending outwardly from the beam portion, the reinforcing rib having a forward end and a rear end, wherein the forward end is flush with or recessed from the flat outer surface of the first or second attachment boss and the rear end is flush with the flat boss contact surface of the barrel;
wherein the barrel extending between the spaced rear ends of the first and second sidebars of a first chain link is disposed between the spaced forward ends of the sidebars of a second chain link such that the barrel pin bore of the first chain link is coaxial with the boss pin bores formed in the first and second attachment bosses of the second chain link;
a chain pin insertable through the boss pin bores of the second chain link and the barrel pin bore of the first chain link for interconnecting the first chain link with the second chain link.

2. The chain link of claim 1 wherein the first attachment boss includes a pin head receptacle recessed from the flat outer surface.

3. The chain link of claim 2 wherein the pin head receptacle has an inner diameter larger than the diameter of the boss pin bore.

4. The chain link of claim 3 wherein the chain pin includes a pin head that is received within the pin head receptacle when the chain pin is positioned to connect the first chain link and the second chain link.

5. The chain link of claim 1 wherein the chain pin is rotatable within the boss pin bores and the barrel pin bore.

6. The chain link of claim 5 further comprising a retaining pin inserted into the second attachment boss and extending through the boss pin bore to prevent axial removal of the chain pin from the boss pin bore while allowing rotation of the chain pin.

7. The chain link of claim 5 wherein the chain pin includes a pin groove that receives the retaining pin.

8. The chain link of claim 6 wherein the retaining pin is flush with both an upper edge and a lower edge of the second attachment boss.

9. The chain link of claim 4 wherein the second attachment boss includes an internal pin opening formed on the inner barrel contact surface, wherein the internal pin opening engages a contact end of the chain pin to prevent rotation of the chain pin.

10. The chain link of claim 9 further comprising a retaining pin inserted into the second attachment boss and extending through the boss pin bore to prevent axial removal of the chain pin from the boss pin bore.

11. The chain link of claim 10 wherein the retaining pin is flush with both an upper edge and a lower edge of the second attachment boss.

12. A chain link for chains such as used in municipal and industrial water and wastewater treatment, and in material handling conveyors, the chain link comprising:
a first sidebar a second sidebar each having a forward end and a rear end, wherein the forward ends of the first and second sidebars are spaced further from each other than the spacing between the rearward ends;
a barrel extending between the spaced rear ends of the first and second sidebars, the barrel including a barrel pin bore and a flat boss contact surface on each of the first and second sidebars;
a first attachment boss formed on the forward end of the first sidebar and a second attachment boss formed on the forward end of the second sidebar, each of the first and second attachment bosses including a flat inner barrel contact surface, a flat outer surface and a boss pin bore extending through the attachment boss, wherein the first attachment boss includes a pin head receptacle recessed from the flat outer surface,
wherein the barrel extending between the spaced rear ends of the first and second sidebars of a first chain link is disposed between the spaced forward ends of the sidebars of a second chain link such that the barrel pin bore of the first chain link is coaxial with the boss pin bores formed in the first and second attachment bosses of the second chain link;
a chain pin insertable through the boss pin bores of the second chain link and the barrel pin bore of the first chain link for interconnecting the first chain link with the second chain link; and
a retaining pin inserted into the second attachment boss and extending through the boss pin bore to prevent axial removal of the chain pin from the boss pin bore,
wherein the retaining pin is flush with both an upper edge and a lower edge of the second attachment boss and the chain pin includes a pin head that is received within the pin head receptacle such that the pin head is flush with or recessed from the flat outer surface of the first attachment boss.

13. The chain link of claim 12 wherein the chain pin is rotatable within the boss pin bores and the barrel pin bore.

14. The chain link of claim 13 wherein the chain pin includes a pin groove that receives the retaining pin.

15. The chain link of claim 12 wherein the second attachment boss includes an internal pin opening formed on the inner barrel contact surface, wherein the internal pin opening engages a contact end of the chain pin to prevent rotation of the chain pin.

16. The chain link of claim 15 wherein the retaining pin extends through a pin opening in the contact end of the chain pin.

17. A chain link for chains such as used in water and wastewater treatment, the chain link comprising:
a first sidebar and a second sidebar each having a forward end and a rear end, wherein the forward ends of the first and second sidebars are spaced further from each other than the spacing between the rearward ends;
a barrel extending between the spaced rear ends of the first and second sidebars, the barrel including a barrel pin bore and a flat boss contact surface on each of the first and second sidebars;
a first attachment boss formed on the forward end of the first sidebar and a second attachment boss formed on the forward end of the second sidebar, each of the first and second attachment bosses including a flat inner barrel contact surface, a flat outer surface and a boss pin bore extending through the attachment boss, wherein each of the first and second sidebars includes a beam portion extending from the attachment boss to the rear end; and
a reinforcing rib extending outwardly from the beam portion, the reinforcing rib having a forward end and a rear end, wherein the forward end is flush with or recessed from the flat outer surface of the first or second attachment boss and the rear end is flush with the flat boss contact surface of the barrel.

18. The chain link of claim 17 wherein the beam portion of each of the first and second sidebars is recessed from the first or second sidebar and is joined to the first or second sidebar by a shoulder.

19. The chain link of claim 17 wherein the rear end of each reinforcing rib terminates at the flat boss contact surface.
